(19) United States
(12) Patent Application Publication
(10) Pub. No.: US 2021/0139083 A1
(43) Pub. Date: May 13, 2021

(54) VEHICLE STRUCTURE AND METHOD FOR CABIN NOISE CONTROL

(71) Applicant: CORNING INCORPORATED, CORNING, NY (US)

(72) Inventors: Vikram Bhatia, Painted Post, NY (US); William Keith Fisher, Corning, NY (US)

(21) Appl. No.: 16/623,593

(22) PCT Filed: Jun. 28, 2018
(86) PCT No.: PCT/US2018/040051

§ 371 Date: Dec. 17, 2019

Related U.S. Application Data
(60) Provisional application No. 62/526,066, filed on Jun. 28, 2017.

(51) Int. Cl. B62D 33/06; B32B 17/10; B60J 1/20; B62D 65/02

(52) U.S. Cl. CPC B62D 33/0604; B32B 17/10045; B32B 17/10761; B60J 1/20; B32B 2605/006; B32B 2250/05; B32B 2307/732; B32B 2307/102; B62D 65/024

(57) ABSTRACT

Aspects of this disclosure pertain to a vehicle comprising: a vehicle body enclosing an interior cabin; a forward-facing opening in communication with the interior; a windshield laminate disposed in the forward-facing opening; at least a pair of side facing openings adjacent the forward-facing opening; and at least one side window laminate disposed in each of the pair of side facing openings, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

### CROSS REFERENCE TO RELATED APPLICATIONS

This application claims the benefit of priority under 35 U.S.C. § 119 of U.S. Provisional Application Ser. No. 62/526,066 filed on Jun. 28, 2017, the content of which is relied upon and incorporated herein by reference in its entirety.

### BACKGROUND

The disclosure relates to a vehicle structure for cabin noise control, and to a method of cabin noise control in a vehicle.

Reduction of the weight of cars to improve fuel economy, reduce CO2 emissions and performance remains a priority among automotive OEMs. One of the paths to reducing weight is to use thinner glazing. Thinner glass sheets or sheets used to form thinner glazing has higher sound transmission; however, when we use such thinner glazing n a system, the higher sound transmission of thin glass windshield and front sidelites (FSLs) is largely masked by higher sound levels resulting from sound transmission through other glazing components and generated by structural vibrations transferred through other non-glazing paths.

Accordingly, there is a need to modify the sound transmission properties of windshields and FSLs to achieve weight savings while minimizing or eliminating an acoustic penalty.

### SUMMARY

A first aspect of this disclosure pertains to a vehicle comprising: a vehicle body enclosing an interior cabin; a forward-facing opening in communication with the interior; a windshield laminate disposed in the forward-facing opening; at least a pair of side facing openings adjacent the forward-facing opening; and at least one side window laminate disposed in each of the pair of side facing openings, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

A second aspect pertains to a method of reducing vehicle cabin noise comprising: installing a windshield laminate, and at least a pair of side window laminates in openings of a vehicle body, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

### BRIEF DESCRIPTION OF THE DRAWINGS

In embodiments of the disclosure:

FIG. 1 shows modeled sound transmission loss (STL) of different individual component window constructions, which STL is an individual component acoustic property.

FIG. 2 shows a variation of AI with different windshield laminates and side window configurations as a function of total weight of the windshield laminates and side windows.

FIG. 3 shows percent of contribution of various glazing components and flanking to wind noise in a wind noise model evaluation.

FIG. 4 is a graph showing increases in the articulation index (“AI”) as the coincidence dip frequency of the front side windows are shifted to a higher frequency.

FIG. 5 shows a schematic of an exemplary vehicle cabin (500).

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### Definitions

“Articulation index,” “AI,” or like terms refer to speech intelligibility and measurement methods thereof.

“Sone,” “sones,” or like terms refer to a unit of how loud a sound is perceived. The sone scale is linear. Doubling the perceived loudness doubles the sone value.

“Octave band,” “one-third octave band,” or like terms as used herein are known in the art of sound measurement, analysis, and scaling. The audible frequency range can be separated into unequal segments called octaves. A band is an octave in width when the upper band frequency is twice the lower band frequency. Octave bands can be separated into three ranges referred to as one-third-octave bands. A one-third octave band is a frequency band whose upper band-edge frequency (f2) is the lower band frequency (f1) times the cube root of two. Each octave band and ⅓ octave band can be identified by a middle frequency, a lower frequency limit and an upper frequency limit (see Acoustical Porous Material Recipes, apmr.matelys.com/Standards/OctaveBands.html, and engineeringtoolbox.com/octave-bands-frequency-limits-d_1602 html).

“Driver,” “passenger,” “occupant,” and like terms refer to a person, a sound recording microphone, or like human or non-human sound sensor situated in the vehicle cabin and within the interior volume defined by the outermost boundaries of the three panel structure of the windshield and the nearest neighboring front side windows and associated glazing or like support fixturing (e.g., a frame), if any.

“Glass,” “glass window,” “window unit,” “side light,” “rear light,” “side lite,” “sky lite,” “windshield,” “windscreen,” or like terms refer to one or more glass laminate structures in a vehicle cabin structure.

“Glass symmetry ratio,” and like terms refer to the thickness ratio of a thicker glass ply or layer to a thinner glass ply or layer in a laminate or hybrid laminate structure.

Laminate constructions may be described in terms of the thickness (in millimeters) of the exterior (or outer) and interior (or inner) glass sheets using the following industry short hand: “Exterior/interior”, “outer/inner”. For example, a 2.5 mm annealed soda lime glass exterior, and a 2.5 mm annealed soda lime glass interior could be described as “2.5/2.5”. It is understood that a polymeric interlayer is disposed between the two glass sheets; however, when a specific interlayer is used, it is identified as follows: 2.5/APVB/2.5, where APVB is an acoustic polyvinyl butyral interlayer.

“Include,” “includes,” or like terms means encompassing but not limited to, that is, inclusive and not exclusive.

The indefinite article “a” or “an” and its corresponding definite article “the” as used herein means at least one, or one or more, unless specified otherwise. Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The article and methods of the disclosure can include any value or any combination of the values, specific values, more specific values, and preferred values described herein, including explicit or implicit intermediate values and ranges.

Aspects of this disclosure relate to mitigating the acoustic penalty that results from using thin glass that is caused by wind and in some cases improving cabin acoustics by using thinner, lightweight glass sheets. Various aspects accomplish this by considering cabin interior acoustics on a system level. Thin glass sheets will have an acoustic penalty relative to thicker glass sheets based on the mass law of sound transmission. However, in a full system environment, the acoustic penalty from thin glass sheets will be relatively small. This is especially true if the thin glass is a laminate where the interlayer contributes significant damping than monolithic glass, thus minimizing high frequency sound radiation into the vehicle cabin interior from the laminate that uses thin glass sheet(s).

Another aspect of this invention is improvement in articulation index realized when the coincidence dip of the FSLs or the combination of FSLs and windshield are shifted to higher frequencies, outside of the range of peak human hearing sensitivity, by using properly designed thin glass laminates with acoustic interlayers (e.g., acoustic polyvinyl butyral or PVB).

A first aspect of this disclosure pertains to a vehicle comprising: a vehicle body enclosing an interior cabin; a forward-facing opening in communication with the interior; a windshield laminate disposed in the forward-facing opening; at least one pair of side facing openings adjacent the forward-facing opening; and at least one side window laminate (which may include a FSL) disposed in each of the pair of side facing openings, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz. In one or more embodiments, the at least one side window laminates disposed in each of the side facing openings are identical to one another.

In one or more embodiments, the design of the vehicle includes selected glazing or laminates such that at least one of the coincidence dip minimums is shifted to a frequency that is outside of from 1,000 to 5,000 Hz such as the range of peak human hearing sensitivity. The glazing components are selected to maximize the articulation index, and minimize the increase of the overall loudness within the cabin while minimizing the combined or total weight of the windshield and side window glazing components.

In embodiments, only the second coincidence dip is outside the range of peak human hearing sensitivity but not the first coincidence dip.

In embodiments, the first coincidence dip and the second coincidence dip both have a frequency outside the range of peak human hearing sensitivity (i.e., less than 1000 Hz and greater than 5000 Hz).

In embodiments, only the second coincidence dip is less than 1000 Hz or greater than 5000 Hz. In one or more embodiments, in one or more specific embodiments, only the second coincidence dip is in a range from greater from 5,000 to 8,000 Hz.

In one or more embodiments, the windshield laminate has a first glass sheet, a second glass sheet having a thickness from about 0.3 mm to less than about 1.5 mm and an interlayer disposed between the first and second glass sheets. The side window laminate has a third glass sheet, a fourth glass sheet with a thickness in a range from about 0.3 mm to less than about 1.5 mm, and an interlayer disposed between the third and fourth glass sheets. In one or more embodiments, the first glass sheet has a thickness in a range from about 1.6 mm to about 3.2 mm (e.g., from about 1.7 mm to about 3.2 mm, from about 1.8 mm to about 3.2 mm, from about 1.9 mm to about 3.2 mm, from about 2 mm to about 3.2 mm, from about 2.1 mm to about 3.2 mm, from about 2.3 mm to about 3.2 mm, from about 1.6 mm to about 3 mm, from about 1.6 mm to about 2.8 mm, from about 1.6 mm to about 2.6 mm, from about 1.6 mm to about 2.5 mm, from about 1.6 mm to about 2.3 mm, or from about 1.6 mm to about 2.1 mm). The thickness of the second glass sheet may be in a range from about 0.4 mm to less than about 1.5 mm, from about 0.5 mm to less than about 1.5 mm, from about 0.55 mm to less than about 1.5 mm, from about 0.6 mm to less than about 1.5 mm, from about 0.7 mm to less than about 1.5 mm, from about 0.8 mm to less than about 1.5 mm, from about 0.9 mm to less than about 1.5 mm, from about 1 mm to less than about 1.5 mm, from about 1.1 mm to less than about 1.5 mm, from about 1.2 mm to less than about 1.5 mm, from about 0.3 mm to 1.4 mm, from about 0.3 mm to 1.2 mm, from about 0.3 mm to 1.1 mm, from about 0.3 mm to 1 mm, from about 0.3 mm to 0.9 mm, from about 0.3 mm to 0.8 mm, from about 0.3 mm to 0.7 mm, from about 0.3 mm to 0.55 mm, from about 0.5 mm to 0.7 mm, from about 0.55 mm to 0.7 mm.

In one or more embodiments, the third glass sheet has a thickness from about 1.6 mm to about 3.2 mm, from about 1.7 mm to about 3.2 mm, from about 1.8 mm to about 3.2 mm, from about 1.9 mm to about 3.2 mm, from about 2 mm to about 3.2 mm, from about 2.1 mm to about 3.2 mm, from about 2.3 mm to about 3.2 mm, from about 1.6 mm to about 3 mm, from about 1.6 mm to about 2.8 mm, from about 1.6 mm to about 2.6 mm, from about 1.6 mm to about 2.5 mm, from about 1.6 mm to about 2.3 mm, or from about 1.6 mm to about 2.1 mm.

In one or more embodiment, the fourth glass sheet has a thickness in a range from about 0.4 mm to less than about 1.5 mm, from about 0.5 mm to less than about 1.5 mm, from about 0.55 mm to less than about 1.5 mm, from about 0.6 mm to less than about 1.5 mm, from about 0.7 mm to less than about 1.5 mm, from about 0.8 mm to less than about 1.5 mm, from about 0.9 mm to less than about 1.5 mm, from about 1 mm to less than about 1.5 mm, from about 1.1 mm to less than about 1.5 mm, from about 1.2 mm to less than about 1.5 mm, from about 0.3 mm to 1.4 mm, from about 0.3 mm to 1.2 mm, from about 0.3 mm to 1.1 mm, from about 0.3 mm to 1 mm, from about 0.3 mm to 0.9 mm, from about 0.3 mm to 0.8 mm, from about 0.3 mm to 0.7 mm, from about 0.3 mm to 0.55 mm, from about 0.5 mm to 0.7 mm, from about 0.55 mm to 0.7 mm.

In one or more specific embodiments, the windshield laminate has a construction of 2.1/0.55 or 2.1/2.1. In one or more embodiments, the side window laminates may have a construction of 2.1/0.5 or 2.1/0.7 (as shown in Table 1).

In one or more embodiments, the windshield laminate has a construction of 2.1/0.55 s, and each of the side window laminates can have ac construction of 2.1/0.55.

In yet another embodiment, the windshield laminate can have a construction of 2.1/0.55 or 2.5/2.5, and each of the side window laminates can have a construction of 2.1/0.7 or 1.8/0.7.

In embodiments, the total weight of the windshield laminate and each of the side window laminates structures is, for example, from 12.3 kilograms to 25.8 kilograms. In one or more embodiments, the combined weight of the windshield laminate and each of the side window laminates may be in a range from about 14 kilograms to 25.3 kilograms, 15 kilograms to 25.8 kilograms, 16 kilograms to 25.8 kilograms, 18 kilograms to 25.8 kilograms, 20 kilograms to 25.8 kilograms, 22 kilograms to 25.8 kilograms, 12.3 kilograms to 25 kilograms, 12.3 kilograms to 24 kilograms, 12.3 kilograms to 22 kilograms, 12.3 kilograms to 20 kilograms, 12.3 kilograms to 18 kilograms, 12.3 kilograms to 16 kilograms, or from 14.5 to 15.5 kilograms, including intermediate values and ranges.

In embodiments, the cabin can have an articulation index %, for example, of from 60 to 67%, and of from 66 to 67%, and a loudness, for example, of from 18 to 27 sones, or from 19.0 to 19.5, including intermediate values and ranges.

In one or more embodiments, the materials used for the windshield laminate and side window laminates may be specified. For example, in one or more embodiments, the first glass sheet faces an exterior of the vehicle and comprises an annealed soda lime glass; the interlayer between the first and second glass sheets comprises PVB; and the second glass sheet faces the interior cabin and comprises a strengthened glass sheet. In one or more embodiments, the third glass sheet faces an exterior of the vehicle and comprises an annealed soda lime glass, the interlayer between the third and fourth glass sheets comprises PVB; and the fourth glass sheet faces the interior cabin and comprises a strengthened glass sheet.

In embodiments that use a strengthened glass sheet, such glass sheets may be strengthened to include compressive stress that extends from a surface to a depth of compression (DOC). The compressive stress regions are balanced by a central portion exhibiting a tensile stress. At the DOC, the stress crosses from a compressive stress to a tensile stress. The compressive stress and the tensile stress are provided herein as absolute values.

In one or more embodiments, the glass sheet may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In one or more embodiments, the glass sheet may be chemically strengthening by ion exchange. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOC and CS of the glass sheet that results from strengthening. Exemplary molten bath composition may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheets may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 1% to about 99% KNO₃ and from about 1% to about 99% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheets is measured by FSM. Central tension or CT is the maximum tensile stress and is measured by SCALP.

In one or more embodiments, the glass sheet maybe strengthened to exhibit a DOC that is described a fraction of the thickness t of the glass sheet (as described herein). For example, in one or more embodiments, the DOC may be equal to or greater than about 0.05t, equal to or greater than about 0.1t, equal to or greater than about 0.11t, equal to or greater than about 0.12t, equal to or greater than about 0.13t, equal to or greater than about 0.14t, equal to or greater than about 0.15t, equal to or greater than about 0.16t, equal to or greater than about 0.17t, equal to or greater than about 0.18t, equal to or greater than about 0.19t, equal to or greater than about 0.2t, equal to or greater than about 0.21t. In some embodiments, The DOC may be in a range from about 0.08t to about 0.25t, from about 0.09t to about 0.25t, from about 0.18t to about 0.25t, from about 0.11t to about 0.25t, from about 0.12t to about 0.25t, from about 0.13t to about 0.25t, from about 0.14t to about 0.25t, from about 0.15t to about 0.25t, from about 0.08t to about 0.24t, from about 0.08t to about 0.23t, from about 0.08t to about 0.22t, from about 0.08t to about 0.21t, from about 0.08t to about 0.2t, from about 0.08t to about 0.19t, from about 0.08t to about 0.18t, from about 0.08t to about 0.17t, from about 0.08t to about 0.16t, or from about 0.08t to about 0.15t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the strengthened glass sheet may have a CS (which may be found at the surface or a depth within the glass sheet) of about 100 MPa or greater, 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater. In one or more embodiments, the strengthened glass sheet may have a CS (which may be found at the surface or a depth within the glass sheet) from about 200 MPa to about 1050 MPa, from about 250 MPa to about 1050 MPa, from about 300 MPa to about 1050 MPa, from about 350 MPa to about 1050 MPa, from about 400 MPa to about 1050 MPa, from about 450 MPa to about 1050 MPa, from about 500 MPa to about 1050 MPa, from about 550 MPa to about 1050 MPa, from about 600 MPa to about 1050 MPa, from about 200 MPa to about 1000 MPa, from about 200 MPa to about 950 MPa, from about 200 MPa to about 900 MPa, from about 200 MPa to about 850 MPa, from about 200 MPa to about 800 MPa, from about 200 MPa to about 750 MPa, from about 200 MPa to about 700 MPa, from about 200 MPa to about 650 MPa, from about 200 MPa to about 600 MPa, from about 200 MPa to about 550 MPa, or from about 200 MPa to about 500 MPa.

In one or more embodiments, the strengthened glass sheets used herein may be strengthened to a low level. For example, the strengthened glass sheet may have a CS (which may be found at the surface or a depth within the glass sheet) of less than about 300 MPa. For example, the CS may be in a range from about 10 MPa to about less than about 300 MPa, from about 20 MPa to about less than about 300 MPa, from about 25 MPa to about less than about 300 MPa, from about 30 MPa to about less than about 300 MPa, from about 40 MPa to about less than about 300 MPa, from about 50 MPa to about less than about 300 MPa, from about 60 MPa to about less than about 300 MPa, from about 70 MPa to about less than about 300 MPa, from about 80 MPa to about less than about 300 MPa, from about 90 MPa to about less than about 300 MPa, from about 100 MPa to about less than about 300 MPa, from about 120 MPa to about less than about 300 MPa, from about 130 MPa to about less than about 300 MPa, from about 140 MPa to about less than about 300 MPa, from about 160 MPa to about less than about 300 MPa, from about 170 MPa to about less than about 300 MPa, from about 180 MPa to about less than about 300 MPa, from about 190 MPa to about less than about 300 MPa, from about 200 MPa to about less than about 300 MPa, from about 10 MPa to about 290 MPa, from about 10 MPa to about 280 MPa, from about 10 MPa to about 270 MPa, from about 10 MPa to about 260 MPa, from about 10 MPa to about 250 MPa, from about 10 MPa to about 240 MPa, from about 10 MPa to about 230 MPa, from about 10 MPa to about 220 MPa, from about 10 MPa to about 210 MPa, from about 10 MPa to about 200 MPa, from about 10 MPa to about 190 MPa, from about 10 MPa to about 180 MPa, from about 10 MPa to about 170 MPa, from about 10 MPa to about 160 MPa, from about 10 MPa to about 150 MPa.

In one or more embodiments, the strengthened glass sheet may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa, from about 50 MPa to about 100 MPa, from about 60 MPa to about 100 MPa, from about 70 MPa to about 100 MPa, from about 80 MPa to about 100 MPa, from about 40 MPa to about 90 MPa, from about 40 MPa to about 80 MPa, from about 40 MPa to about 70 MPa, or from about 40 MPa to about 60 MPa.

In some embodiments, when the strengthened glass sheet has a relatively low surface CS, the corresponding CT may also be relatively low (e.g., about 50 MPa or less).

In one or more embodiments, the the interlayer is a polymer interlayer selected from the group consisting of polyvinyl butyral (PVB), ethylenevinylacetate (EVA), polyvinyl chloride (PVC), ionomers, and thermoplastic polyurethane (TPU). The interlayer may be applied as a preformed polymer interlayer. In some instances, the polymer interlayer can be, for example, a plasticized polyvinyl butyral (PVB) sheet. In various embodiments, the polymer interlayer can comprise a monolithic polymer sheet, a multilayer polymer sheet (e.g., such as an acoustic interlayer), or a composite polymer sheet.

In one or more embodiments, the windshield laminate and the side window laminate are selected from the group consisting of: three separate adjacent window components and having an A-pillar separating adjacent window components, and a single laminate structure having out-of-plane contours and out-of-plane bends forming the side facing windows and without an A-pillar separation structure.

In one or more embodiments, the cabin can be selected from, for example: a driver or driverless vehicle; a combustion, electric, solar, or hybrid powered vehicle; an automobile; a sport utility vehicle; a truck; a bus; a golf cart; a motorcycle; a train; a watercraft; an aircraft; and like vehicles; or a combination thereof.

A second aspect of this disclosure pertains to a method of reducing vehicle cabin noise. In one or more embodiments, the method includes installing a windshield laminate (as described herein), and at least a pair of side window laminates (as described herein) in openings of a vehicle body. In one or embodiments, the method includes installing a windshield laminate that has a first coincident dip minimum at a first frequency. In one or more embodiments, the method includes installing side window laminates that each have a second coincident dip minimum at a second frequency. In one or more embodiments, at least one of or both the first frequency and the second frequency is less than 1000 Hz or greater than 5000 Hz. In some embodiments, only the second frequency is less than 1000 Hz or greater than 5000 Hz. In one or more specific embodiments, the second frequency is in a range from greater than 5,000 Hz to 8,000 Hz. In one or more embodiments, both the first frequency and the second frequency are less than 1,000 Hz or greater than 5,000 Hz.

In one or more embodiments, the method includes installing a windshield laminate comprises a first glass sheet and a second glass sheet that differ in thickness and strength levels from one another, and installing side window laminates comprises a third glass sheet and a fourth glass sheet that differ in thickness and strength levels from one another. In one or more specific embodiments, the windshield laminate comprises a first glass sheet and a second glass sheet that differ in thickness and glass composition from one another, and the side window laminate comprises a third glass sheet and a fourth glass sheet that differ in thickness and glass composition from one another.

In embodiments, the method of reducing cabin noise can further comprise operating the vehicle.

In embodiments, the vehicle can be, for example, stationary or is in motion while operating.

In embodiments, the disclosure provides a method of making the above mentioned vehicle, comprising:

installing the forward facing windshield laminate structure, and at least a pair of front side facing windows laminate structures about the cabin of the vehicle, and at least one of the first coincidence dip minimum and the second coincidence dip minimum have a frequency outside of from 1,000 to 5,000 Hz, which includes the range of peak human hearing sensitivity.

In embodiments, the method, prior to installing, can further comprise modeling at least one of a combination of the forward facing windshield laminate structure and at least a pair of front side facing windows laminate structures, and selecting the at least one of the modeled combinations that has at least one of the first and second coincidence dip minima with a frequency outside of from 1,000 to 5,000 Hz.

In a one or more embodiments, the method includes installing a windshield laminate having a construction of 2.1/1.6, and installing side window laminates each having a construction of 2.1/0.7.

Referring to Table 4, for a vehicle with a 2.1/1.6 windshield laminate, replacing two 3.85 mm-thick monolith FSLs with two identical side window laminates having a construction of 2.1/0.7 results in a decrease in loudness of 1.6 sones and increase in articulation index of 11.4% relative to the reference. This reduction in loudness is a result of shifting the coincidence dip minimum frequency from 3150 Hz for the 3.85 mm-thick monoliths to 6300 Hz for the 2.1/0.7 side window laminates. The weight saving is 1.2 kg.

Replacement of the 2.1/0.7 side window laminate with a less stiff 1.8/0.7 side window laminate shifts the coincidence dip minimum frequency from 6,300 Hz to 8,000 Hz. This shift results in a slight increase in loudness of 0.2 sones and decrease in articulation indiex of 0.8%. The weight savings is 1.6 kg. In this case further shift of the coincidence dip minimum frequency to from 6300 Hz to 8000 Hz does not compensate for the increase in loudness and reduction in articulation index caused by higher sound transmission in the mass controlled frequency range. However, use of a 1.8/0.7 side window laminate provides additional weight saving over 2.1/0.7 with only small changes in loudness and articulation index.

Referring again to Table 4, a similar line of reasoning for use of a 2.1/0.55 windshield laminates leads to the conclusion that, for optimal acoustics, 2.1/0.7 side window laminates should be used. Increased weight savings of 0.3 kg can be realized by using 1.8/0.7 side window laminates with only small changes in loudness and articulation index.

In one or more embodiments, decreased loudness, increased articulation index, weight savings, or combinations thereof, can be achieved by shifting the coincidence dip minimum frequency from the frequency range of peak human hearing to higher frequencies in the range between 6,300 Hz to 8,000 Hz. For lowest loudness and greatest articulation index, coincidence dip minimum frequencies of both windshield laminates and side window laminates can be outside of the range of peak human hearing such as in the following embodiments:

2.1/1.6 windshield laminates used with 2.1/0.7 side window laminates; 2.1/1.6 windshield laminates used with 1.8/0.7 side window laminates; 2.1/0.55 windshield laminates used with 2.1/0.7 side window laminates; and 2.1/0.55 windshield laminates used with 1.8/0.7 side window laminates.

Sound transmission through a window panel is determined by its surface density (mass per unit area), its stiffness, and its damping. Doubling surface density will reduce the amount of sound energy transmitted by 3 dB between about 400 Hz and 1,250 Hz. This frequency range is called the mass law region. However, in the frequency range between about 2,500 Hz and 6,300 Hz sound transmission is dominated by the panel coincidence dip. The coincidence dip or minimum is frequency or a range of frequencies between which the sound blocking capability of a window panel is reduced so that more sound energy is transmitted. The frequency of the coincidence dip minimum is inversely related to window panel stiffness, and the degree of increased sound transmission is inversely related to window panel damping.

Sound transmission through a panel is characterized by its sound transmission loss (STL). STL is measured by positioning a glazing panel between a sound source room and a receiving room such that almost all of the sound generated in the source room can reach the receiving room only by passing through the glazing panel. “STL” is the difference between sound pressure level (SPL) in the source room and SPL in the receiving room. Methods of measuring STL are described in standards ASTM E90 and SAE J1400.

Referring to the Figures, FIG. 1 shows individual component STL curves for a variety of laminate constructions. Coincidence dip minima can vary with panel construction. The 4.85 mm soda lime glass (SLG) monolith is the stiffest and lowest damping of the panels so it has the deepest coincidence dip at the lowest frequency. Laminated constructions, where damping is introduced through the acoustic PVB (APVB) interlayer, have much shallower coincidence dips at higher frequencies relative to the monolith as a consequence of their lower stiffness. Within the family of laminates the frequency of coincidence dip minima depends on both laminate thickness and asymmetry of component glass thicknesses. An asymmetric laminate (3.5/0.7)(160) is stiffer than a symmetric laminate (e.g., 2.1/2.1)(150) of same total glass thickness so it will have a lower coincidence dip minimum frequency. The coincidence dip minimum of 3.5/0.7 occurs at 4,000 Hz whereas the coincidence dip minimum for 2.1/2.1 occurs at 5,000 Hz. For thinner, lower stiffness, 2.1/0.7 and 2.1/0.5 laminates, their coincidence dip minima occur at 6,300 Hz. The key aspect is that the frequency and depth of coincidence dips can be controlled by laminate construction, i.e., through controlling stiffness and damping.

Modeled STL plots in FIG. 1 show mass controlled region (100) having simple and superior sound blocking region (120), and the coincidence, stiffness, and damping controlled region (110). A baseline reference is the 4.85 mm monolith (170). Another baseline reference is the 2.1/2.1 laminate of a 2.1SLG/APVB/0.7SLG FS combination (150). An example STL laminate is the 3.5/0.7 laminate structure of the formula 3.5SLG/APVB/0.7GG FS (160). Another example STL laminate is the 2.1SLG/APVB/0.7 Gorilla Glass® (“GG”) (140). Still another example STL laminate is the 2.1SLG/APVB/0.5 GG (130).

Results obtained from validated full system wind noise models, which include all glazing positions and non-glazing flanking paths, show that, even though thin light weight glass shows an acoustic penalty when considered individually, that penalty is largely masked or essentially eliminated when considering a full vehicle system. The disclosed model examples show that, with proper selection of windshield and FS constructions, significant glazing or vehicle weight reductions can be achieved with little acoustic penalty.

Interior cabin acoustics can be characterized in terms of overall perceived loudness and speech intelligibility. Overall loudness is measured in sones that is linearly related to perceived loudness. Speech intelligibility is measured as a percent of the articulation index (AI). Greater AI or enhanced AI means more clear speech recognition by a listener, for example, locally (i.e., present in the vehicle cabin) or remotely (i.e., on a cell phone) through background noise Enhanced AI is particularly useful with, for example, the use of voice controlled devices or voice recognition technology in vehicles.

The frequency range of most sensitive hearing and where AI is most affected is between 1,000 and 5,000 Hz. With proper selection of thin glass structures or constructions for side windows (including FSLs) and windshield, their coincidence dip frequencies can be increased so that they are outside the range of most sensitive human hearing.

Results listed in Table 1 show increasing AI and sones for thinner laminate combinations. The results were calculated using the full system sport utility vehicle (SUV) simplified wind noise model. All laminates were made with acoustic PVB.

Wind noise source strength is highest for the FSLs because of turbulent pressure fluctuations generated as wind flows around the A pillar. The A pillar is the pillar between the windshield glass component and the front side glass component.

The windshield is of secondary importance. This can be seen by examining results in FIG. 2 that show AI as function of weight of windshield and FSLs for different windshield and FSL combinations. Substituting two 2.1/0.7 side window laminates (having a 0.7-mm thick strengthened glass sheet and having a total weight or mass of 4.0 kg) for two 4.85 mm-thick monolithic side windows (having a total weight or mass of 6.2 kg) increases AI by an average of 3.5%. AI is increased by an average of 5.8% when two 2.1/2.1 a side window laminates are substituted for two 4.85 mm-thick monolithic side windows. The effect of windshield construction on AI is much less. Varying windshield construction from 2.1/0.7 (11.27 kg) to 2.5/2.5 (19.24 kg) results in an average increase in AI of 1.0% for all three side window laminate types. The difference in AI between 2.3/2.3 (17.80 kg) and 2.5/2.5 (19.24 kg) windshield laminates is only an average of 0.1% and between 1.8/1.8 (14.2 kg) and 2.5/2.5 is on average 0.5%. Weight savings can be achieved by reducing the weight of the windshield with little penalty in AI.

Another way of demonstrating the dominance of the side sindows as a source of wind noise is to calculate the percent contribution to interior cabin sound energy for each glazing position. This was done for a mid-size sedan automobile having a 2.1/1.6 windshield laminate and two 3.85 mm-thick monolithic side windows. The results are shown in FIG. 3. The side windows clearly the dominant contributor in the frequency range of most sensitive hearing. Accordingly, reducing weight of the windshield laminate will have little effect on the overall cabin interior sound level in the frequency range of most sensitive hearing. Other glazing components or alternatives can be substituted with thinner laminates, such as for example: a 3.85 mm-thick monolithic sunroof (SR); a 3.15 mm-thick monolithic back light or rear window (BL); a 3.15 mm-thick monolithic rear side light or rear side window (RSL); and a 3.85 mm-thick monolithic front side light or front side window (FS). Other non-glazing components can include, for example, flanking, i.e., sound transmitted into the vehicle cabin from all non-glazing acoustic paths.

Results listed in Table 1 show that substantial weight savings can be realized through proper selection of the windshield and side window laminate construction. A baseline reference is the combination of a 2.1/2.1 windshield laminate, and two 4.85 mm-thick monolith side windows. Reduction in weight of the windshield by 5.1 kg through substitution with a 2.1/0.7 laminate results in a decrease in AI by 0.8% and an increase in overall loudness by 1.1 sones. Keeping the windshield laminate as a 2.1/0.7 construction, and substituting two 4.85 mm-thick monolith side windows with two 2.1/0.5 side window laminates shifts the coincidence dip minimum frequency of the side windows from 2,500 out to 6,300 Hz. This shift in coincidence dip to higher frequency, outside the range of peak hearing sensitivity, results in an increase in AI of 2.1% with only a modest increase in overall loudness of 0.9 sones.

As described herein, the coincidence dip frequency can be shifted out of the range of peak hearing sensitivity by using thinner laminates which optionally include a thin, strengthened glass sheet. Shifting coincidence dip frequencies to above 5,000 Hz result in weight savings and improved (increased) articulation index. To reduce weight with a minimum acoustic penalty or with an acoustic benefit, the coincidence dip frequency of the glazing component having the highest source intensity, in this instance the side window, should be shifted out of the range of peak hearing sensitivity.

Because of the dominance of front side windows, further improvement in AI can be accomplished by reducing the surface density of the windshield, and increasing the surface density of the front side windows. For example compare the 2.1/0.7 windshield and 2.1/0.5 FS combination model with the 2.1/0.6 windshield and 2.1/0.6 FS combination model. Reducing windshield surface density and increasing front side glass surface density resulted in an increase in AI by 0.3% and reduction in total weight by 0.23 kg, and overall loudness does not change. Removing weight from the windshield, which has large area and relative insensitivity to wind noise, results in weight savings and improved acoustics.

TABLE 1
Weight savings or weight reduction achieved by selection
of windshield and FS acoustic laminate construction.

| | Wind- | Front side | Front side | Total | | |
|---|---|---|---|---|---|---|
| | shield | glass | glass weight | weight | AI | |
| | (WS) | (FS) | (kg) | (kg) | (%) | Sones |
| Control | 2.1/2.1 | 4.85 mm | 6.61 | 22.60 | 64.2 | 18.3 |
| | | monolith | | | | |
| Control | 2.1/0.7 | 4.85 mm | 6.21 | 17.48 | 63.4 | 19.4 |
| | | monolith | | | | |
| Example | 2.1/0.7 | 2.1/0.5 | 3.75 | 15.02 | 66.3 | 19.2 |
| Example | 2.1/0.6 | 2.1/0.6 | 3.88 | 14.79 | 66.6 | 19.2 |

Table 2 list results that show the effect on AI of increasing coincidence dip minimum frequency of the FSs from 2,500 Hz for a 4.50 mm monolith to 5,000 Hz for a 2.1/2.1 laminate construction. For a 2.1/0.7 windshield, AI is increased by 6.4% by shifting the FS coincidence dip minimum from 2,500 to 5,000 Hz.

Decreasing the weight of the windshield from 17.8 kg for a 2.3/2.3 to 11.3 kg for a 2.1/0.7 windshield (with 2.1/2.1 acoustic laminate FS's) only decreases AI by 1%. There is a mass law penalty for 2.1/0.7 but some of that is recovered because the coincidence dip minimum frequency is shifted from 5,000 Hz for the 2.3/2.3 to 6,300 Hz for the 2.1/0.7 This is an example of removing weight from a glazing element that is less sensitive to wind noise yielding weight savings with only a minor acoustic penalty.

TABLE 2
Effect on AI of increasing coincidence dip minimum frequency.

| Windshield | Front side glass | AI % |
|---|---|---|
| 2.1/0.7 acoustic laminate | 4.50 mm monolith | 62.79 |
| 2.1/0.7 acoustic laminate | 3.5/0.7 acoustic laminate | 67.83 |
| 2.1/0.7 acoustic laminate | 2.1/2.1 acoustic laminate | 69.14 |
| 2.3/2.3 acoustic laminate | 2.1/2.1 acoustic laminate | 70.13 |

FIG. 4 is a plot of the AI % vs. FS coincidence dip minimum frequency tabulated in Table 2 where the FS surface density is kept constant, equivalent to the surface density of a 4.50 mm thick monolithic glass. Increasing the FS coincident dip minimum frequency from 2,500 to 5,000 Hz results in an increase in AI of over 6%. Increasing windshield laminate thickness has a smaller effect.

FIG. 5 shows a schematic of an exemplary vehicle cabin (500) including: a windshield (510); a left front side window (520); a right front side window (530); a left occupant (e.g., a driver) (540); a right occupant (e.g., a passenger) (550); and a microphone or sound sensor (560) near the driver's ear.

The following mentions windshield and front side window dimensions that were modeled. The vehicle cabin interior dimensions and acoustic absorption were constant for all models:

Windshield (WS) sizes were from 1.17 to 1.44 m²;
Front side glass (FS) sizes were from 0.25 to 0.42 m²; and
Cabin airspace dimensions were constant for all window combination modeling: L=2200 mm; W=700 mm; and H=1100 mm

The time for the SPL of a sound pulse within a vehicle cabin to decrease by 60 dB (“T60”) was used to define interior cabin sound absorption and was constant for all models. T60 is a function of frequency as indicated in Table 3.

TABLE 3
SPL diminution with cabin absorption.

| Frequency (Hz) | Time (mS) |
|---|---|
| 3150 | 95 |
| 4000 | 100 |
| 5000 | 110 |
| 6300 | 170 |
| 8000 | 250 |
| 10000 | 250 |

The non-glazing acoustic flanking paths were characterized by sound transmission loss vs. frequency that follows the mass law. Ranges of sound transmission loss used for flanking are listed in Table 4.

TABLE 4

| Frequency (Hz) | STL ranges (dB) |
|---|---|
| 3150 | 27-48 |
| 4000 | 29-50 |
| 5000 | 31-52 |
| 6300 | 33-54 |
| 8000 | 35-56 |
| 10000 | 37-58 |

The trends in SPL with the disclosed windshield and front side window combinations were not significantly affected by flanking.

### EXAMPLES

The following Examples demonstrate making, use, and analysis of the disclosed vehicle glazing structures and methods in accordance with the above general procedures.

The results provided in the following Examples were obtained using validated finite elements models for laminated glass stiffness and damping properties based on the glass and the PVB interlayer modulus and damping properties. The interior vehicle sound pressure level (SPL) was calculated using validated statistical energy analysis models where the laminate stiffness and damping were inputs.

The laminates used in these examples included a thin glass sheet of aluminosilicate glass that was chemically strengthened.

In the following examples SPL refers to interior vehicle sound pressure level that was calculated using a validated statistical energy analysis model (SEAM®) software from Cambridge Collaborative, Inc., Golden, Colo. Table 3 summarizes the results of the working examples.

TABLE 3
Summary of working example results.

| Example | Glazing combination results and comparisons |
|---|---|
| 1 | A laminate is substituted for monolithic side windows |
| | resulting in decreased loudness and increased AI. |
| 2 | A thin acoustic laminate windshield is substituted for a |
| | thick acoustic laminate windshield. This substitution results |
| | in an acoustic penalty, i.e., an increase in loudness and a |
| | decrease in AI. |
| 3 | A laminate is substituted for monolithic FS windows. The |
| | acoustic penalty in Example 2 is compensated for to the extent |
| | that loudness is decreased and AI increased relative to the |
| | reference configuration. |
| 4 | Shows a decrease in loudness and an increase in AI by |
| | increasing the frequency of coincidence dip minimum of both |
| | windshield and FS windows. |

### Example 1

Reduced vehicle cabin noise achieved by displacing the coincidence dip minima of the front side glass to outside the range of peak human hearing. Reduced vehicle cabin noise can be achieved by displacing the coincidence dip minima of the front side glass outside of the range of peak human hearing. Referring to Table 4, the loudness level in sones and the articulation index (AI) for a reference vehicle cabin having 2.1/1.6 windshield and 3.85 mm monolithic front side windows is listed. Substitution of a light weight laminate having a 2.1/0.7 side window laminate structure for the 3.85 mm monolith front side windows results in a weight savings of 1.2 kg, and produces a reduction in loudness of 1.6 sones and increases the AI of 11.4%. This example illustrates that substituting a laminate for a monolithic glass in the front side window positions results in a significant improvement in interior cabin acoustics as evidenced by the decrease in loudness and increase in AI. The front side window is the glazing element having the highest transmission of wind noise.

The acoustic PVB interlayer (i.e., APVB) within the laminate reduces its stiffness and increases damping. Reduced stiffness shifts the coincidence dip from about 3150 Hz for the monolithic glass to about 6300 Hz for the laminate glass. 6300 Hz is outside of the range of peak hearing so, by shifting the coincidence dip up to 6300 Hz, the perceived loudness decreases and speech intelligibility is improved. A decrease in sones or an increase in the AI provides loudness performance improvement.

TABLE 4
Loudness level in sones and the articulation index (AI)
for a comparative reference structure and changes in sones
and AI for experimental cabin glazing combinations.

| | | Wind noise | Weight savings |
|---|---|---|---|
| | | model | or reduced weight |
| WS | FS | Δ sones/AI | (kg) |
| 2.1/1.6 | 3.85 mm | Reference | Reference |
| | | 18.9/65.3% | (actual wt. = 30.7 kg) |
| 2.1/1.6 | 2.1/0.7 | −1.6/11.4 | 1.2 |
| 2.1/0.55 | 3.85 mm | 0.8/−0.6 | 3.1 |
| 2.1/0.55 | 2.1/0.7 | −0.8/10.7 | 4.3 |
| 2.1/0.55 | 1.8/0.7 | −0.7/10.1 | 4.6 |

### Example 2

Change in vehicle cabin noise obtained by substituting a thin acoustic laminate windshield for a thick acoustic laminate windshield. Referring again to Table 4, substitution of a 2.1/0.55 windshield laminate for the reference 2.1/1.6 laminate windshield results in a weight savings of 3.1 kg, an increase in loudness of 0.8 sones, and a decrease in AI of 0.6%. In this example a lighter acoustic laminate is substituted for heavier acoustic laminate where the coincidence dips are both at about 6300 Hz. The increase in loudness is a result of the mass law of acoustics since both laminates have comparable damping.

### Example 3 (Prophetic)

Referring again to Table 4 and Example 2, the windshield is a 2.1/0.55 laminate and the front side windows are 3.85 mm monolithic glass. Substitution of the 3.85 mm monolith (reference) front side windows with a front side window laminate having a construction of 2.1/0.7 results in a weight savings of 4.3 kg relative to reference, a reduction in loudness of 0.8 sones relative to reference, and an increase in AI of 10.7% relative to the reference. This example illustrates that an acoustic penalty that can result from substituting a thin acoustic windshield laminate for a thick acoustic windshield laminate (Example 2) can be compensated for or mitigated by substituting thin acoustic laminates for monoliths at the FS positions. In this specific example substituting thin acoustic laminates resulted in reduced weight benefit and improved acoustics relative to the reference.

### Example 4

Reduced vehicle cabin noise obtained by displacing the coincidence dip minima of the windshield and the front side glass to outside the range of peak human hearing. Referring to Table 4, the reference model corresponds to a vehicle having a laminate with standard non-acoustic PVB (“SPVB”) windshield of the construction 2.1/SPVB/2.1. The coincidence dip minimum frequency for this laminate occurs at 3150 Hz. Substitution of this windshield with a laminate containing an acoustic PVB (“APVB”) of the construction 2.1/APVB/2.1 results in a decrease in the loudness of 0.9 sones and an increase in AI of 4.5%. The 2.1/APVB/2.1 laminate has a coincidence dip minimum frequency at 5000 Hz, two ⅓ octave intervals higher than the 2.1/SPVB/2.1. Keeping the 2.1/APVB/2.1 windshield and substituting 2.1/APVB/0.7 laminates for the 3.85 mm monolith front side windows results in a decrease in loudness of 2.2 sones and increase in AI of 13.3%.

TABLE 4
Noise reduction and weight savings for a comparative control
reference and two experimental cabin glazing combinations.

| | | Wind noise | Weight savings |
|---|---|---|---|
| | FS | model | or reduced weight |
| WS | Windows | Δ sones/AI | (kg) |
| Control | Control | Control | Control |
| 2.1/SPVB/2.1 | 3.85 mm | 20.4/58.3% | (actual wt. = 32.1 kg) |
| 2.1/APVB/2.1 | 3.85 mm | −0.9/4.5 | 0 |
| 2.1/APVB/2.1 | 2.1/APVB/0.7 | −2.2/13.3 | 1.2 |

Aspect (1) of this disclosure pertains to a vehicle comprising: a vehicle body enclosing an interior cabin; a forward-facing opening in communication with the interior; a windshield laminate disposed in the forward-facing opening; at least a pair of side facing openings adjacent the forward-facing opening; and at least one side window laminate disposed in each of the pair of side facing openings, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

Aspect (2) pertains to the vehicle of Aspect (1), wherein only the second frequency is less than 1,000 Hz or greater than 5,000 Hz.

Aspect (3) pertains to the vehicle of Aspect (1), wherein the first frequency and the second frequency are less than 1,000 Hz or greater than 5,000 Hz.

Aspect (4) pertains to the vehicle of any one of Aspects (1)-(3), wherein the second frequency is in a range from greater than 5,000 Hz to 8,000 Hz.

Aspect (5) pertains to the vehicle of any one of Aspects (1)-(4), wherein the windshield laminate has a first glass sheet, a second glass sheet having a thickness from about 0.3 mm to less than about 1.5 mm and an interlayer disposed between the first and second glass sheets, and the side window laminates has a third glass sheet, a fourth glass sheet with a thickness in a range from about 0.3 mm to less than about 1.5 mm, and an interlayer disposed between the third and fourth glass sheets.

Aspect (6) pertains to the vehicle of Aspect (5), wherein the first glass sheet has a thickness from about 1.6 m to about 2.1 mm, the second glass sheet has a thickness of about 0.5 mm to about 0.7 mm, the third glass sheet has a thickness from about 1.6 mm to about 2.1 mm and the fourth glass sheet has a thickness from about 0.5 mm to about 0.7 mm.

Aspect (7) pertains to the vehicle of any one of Aspects (1)-(6), wherein the windshield laminate and the side window laminates has a combined weight in a range from about 12.3 kilograms to about 25.8 kilograms.

Aspect (8) pertains to the vehicle of Aspect (7), wherein the interior cabin has an articulation index % of from 60 to 67% and a loudness of from 18 to 27 sones.

Aspect (9) pertains to the vehicle of any one of Aspects (1)-(8), wherein the first glass sheet faces an exterior of the vehicle and comprises an annealed soda lime glass; the interlayer between the first and second glass sheets comprises polyvinyl butyral (PVB); and the second glass sheet faces the interior cabin and comprises a strengthened glass sheet, and the third glass sheet faces an exterior of the vehicle and comprises an annealed soda lime glass; the interlayer between the third and fourth glass sheets comprises polyvinyl butyral (PVB); and the fourth glass sheet faces the interior cabin and comprises a strengthened glass sheet.

Aspect (10) pertains to the vehicle of any one of Aspects (1)-(9), wherein the windshield laminate and the side window laminate are selected from the group consisting of: three separate adjacent window components and having an A-pillar separating adjacent window components; and a single laminate structure having out-of-plane contours and out-of-plane bends forming the side facing windows and without an A-pillar separation structure.

Aspect (11) pertains to the vehicle of any one of Aspects (1)-(10), wherein the cabin is selected from a driver or driverless vehicle, an automobile, a sport utility vehicle, a truck, a bus, a train, a cart, a motorcycle, a watercraft, an aircraft, or a combination thereof.

Aspect (12) of this disclosure pertains to a method of reducing vehicle cabin noise comprising: installing a windshield laminate, and at least a pair of side window laminates in openings of a vehicle body, wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

Aspect (13) pertains to the method of Aspect (12), wherein the windshield laminate comprises a first glass sheet and a second glass sheet that differ in thickness and strength levels from one another, and the side window laminate comprises a third glass sheet and a fourth glass sheet that differ in thickness and strength levels.

Aspect (14) pertains to the method of Aspect (12), wherein the windshield laminate comprises a first glass sheet and a second glass sheet that differ in thickness and glass composition from one another, and the side window laminate comprises a third glass sheet and a fourth glass sheet that differ in thickness and glass composition from one another

Aspect (15) pertains to the method of any one of Aspects (12)-(14), wherein only the second frequency is less than 1,000 Hz or greater than 5,000 Hz.

Aspect (16) pertains to the method of any one of Aspects (12)-(15), wherein the first frequency and the second frequency are less than 1,000 Hz or greater than 5,000 Hz.

Aspect (17) pertains to the method of any one of Aspects (12)-(16), wherein the second frequency is in a range from greater than 5,000 Hz to 8,000 Hz.

The disclosure has been described with reference to various specific embodiments and techniques. However, many variations and modifications are possible while remaining within the scope of the disclosure.

1. A vehicle comprising:
a vehicle body enclosing an interior cabin;
a forward-facing opening in communication with the interior;
a windshield laminate disposed in the forward-facing opening;
at least a pair of side facing openings adjacent the forward-facing opening; and
at least one side window laminate disposed in each of the pair of side facing openings,
wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

2. The vehicle of claim 1, wherein only the second frequency is less than 1,000 Hz or greater than 5,000 Hz.

3. The vehicle of claim 1, wherein the first frequency and the second frequency are less than 1,000 Hz or greater than 5,000 Hz.

4. The vehicle of claim 1, wherein the second frequency is in a range from greater than 5,000 Hz to 8,000 Hz.

5. The vehicle of claim 1, wherein the windshield laminate has a first glass sheet, a second glass sheet having a thickness from about 0.3 mm to less than about 1.5 mm and an interlayer disposed between the first and second glass sheets, and the side window laminates has a third glass sheet, a fourth glass sheet with a thickness in a range from about 0.3 mm to less than about 1.5 mm, and an interlayer disposed between the third and fourth glass sheets.

6. The vehicle of claim 5, wherein the first glass sheet has a thickness from about 1.6 m to about 2.1 mm, the second glass sheet has a thickness of about 0.5 mm to about 0.7 mm, the third glass sheet has a thickness from about 1.6 mm to about 2.1 mm and the fourth glass sheet has a thickness from about 0.5 mm to about 0.7 mm.

7. The vehicle of claim 1, wherein the windshield laminate and the side window laminates has a combined weight in a range from about 12.3 kilograms to about 25.8 kilograms.

8. The vehicle of claim 7, wherein the interior cabin has an articulation index % of from 60 to 67% and a loudness of from 18 to 27 sones.

9. The vehicle of claim 1, wherein
the first glass sheet faces an exterior of the vehicle and comprises an annealed soda lime glass; the interlayer between the first and second glass sheets comprises polyvinyl butyral (PVB); and the second glass sheet faces the interior cabin and comprises a strengthened glass sheet, and
the third glass sheet faces an exterior of the vehicle and comprises an annealed soda lime glass; the interlayer between the third and fourth glass sheets comprises polyvinyl butyral (PVB); and the fourth glass sheet faces the interior cabin and comprises a strengthened glass sheet.

10. The vehicle of claim 1, wherein the windshield laminate and the side window laminate are selected from the group consisting of: three separate adjacent window components and having an A-pillar separating adjacent window components; and a single laminate structure having out-of-plane contours and out-of-plane bends forming the side facing windows and without an A-pillar separation structure.

11. The vehicle of claim 1, wherein the cabin is selected from a driver or driverless vehicle, an automobile, a sport utility vehicle, a truck, a bus, a train, a cart, a motorcycle, a watercraft, an aircraft, or a combination thereof.

12. A method of reducing vehicle cabin noise comprising:
installing a windshield laminate, and at least a pair of side window laminates in openings of a vehicle body,
wherein the windshield laminate has a first coincident dip minimum at a first frequency, and the side window laminate has a second coincident dip minimum at a second frequency, wherein at least one of or both the first frequency and the second frequency is less than 1000 Hz or greater than 5000 Hz.

13. The method of claim 12, wherein the windshield laminate comprises a first glass sheet and a second glass sheet that differ in thickness and strength levels from one another, and the side window laminate comprises a third glass sheet and a fourth glass sheet that differ in thickness and strength levels.

14. The method of claim 12, wherein the windshield laminate comprises a first glass sheet and a second glass sheet that differ in thickness and glass composition from one another, and the side window laminate comprises a third glass sheet and a fourth glass sheet that differ in thickness and glass composition from one another.

15. The method of claim 12, wherein only the second frequency is less than 1,000 Hz or greater than 5,000 Hz.

16. The method of claim 12, wherein the first frequency and the second frequency are less than 1,000 Hz or greater than 5,000 Hz.

17. The method of claim 12, wherein the second frequency is in a range from greater than 5,000 Hz to 8,000 Hz.
